(19) United States
(12) Patent Application Publication
(10) Pub. No.: US 2021/0097633 A1
(43) Pub. Date: Apr. 1, 2021

(54) INFORMATION PROCESSING APPARATUS, VEHICLE, INFORMATION PROCESSING SYSTEM, AND NON-TRANSITORY COMPUTER READABLE MEDIUM

(71) Applicant: TOYOTA JIDOSHA KABUSHIKI KAISHA, Toyota-shi (JP)

(72) Inventors: Ryuichi KAMAGA, Nisshin-shi (JP); Kouki MORIYA, Nagakute-shi (JP); Yui OGURA, Nagoya-shi (JP); Shintaro MATSUTANI, Kariya-shi (JP)

(73) Assignee: TOYOTA JIDOSHA KABUSHIKI KAISHA, Toyota-shi (JP)

(21) Appl. No.: 17/011,894

(22) Filed: Sep. 3, 2020

(30) Foreign Application Priority Data
Sep. 26, 2019 (JP) 2019-176074

(51) Int. Cl. G06Q 50/20; G06Q 10/06

(52) U.S. Cl. CPC G06Q 50/205; G09B 15/00; G06Q 10/06314

(57) ABSTRACT

An information processing apparatus includes a controller. The controller acquires holding information on a music class to be held in a vehicle and provision information on a provider who provides a music supply to be used in the music class. The controller executes matching between the music class and the provider based on the holding information and the provision information that are acquired, and determines procurement information to be notified to the provider, according to a result of the matching.

### CROSS-REFERENCE TO RELATED APPLICATION

This application claims priority to Japanese Patent Application No. 2019-176074, filed on Sep. 26, 2019, the entire contents of which are incorporated herein by reference.

### TECHNICAL FIELD

The present disclosure relates to an information processing apparatus, a vehicle, an information processing system, and a program.

### BACKGROUND

Music classes held among an instructor and a student at a predetermined date and time, and in a vehicle stocked with music supplies including a musical instrument and a musical score, are known. For example, Patent Literature (PTL) 1 discloses a vehicle used for a mobile class, in the main body of which a space for playing a musical instrument is secured and formed, a musical instrument being installed in the space so that a musical instrument playing lesson using the installed musical instrument can be provided. In such a music class, for example, a music supply to be used in teaching music is held in the vehicle used for the mobile class.

### CITATION LIST

### Patent Literature

PTL 1: JP 2001-277932 A

### SUMMARY

In a conventional vehicle used for a mobile class as described in PTL 1, a music supply is installed in the vehicle, and thus a locational burden of owning the music supply and an economic burden such as a maintenance cost for the music supply are imposed on an owner who owns the music supply.

It would therefore be helpful to enable reduction of the burden on an owner, which accompanies ownership of a music supply in a music class.

An information processing apparatus according to an embodiment of the present disclosure includes a controller configured to:

acquire holding information on a music class to be held in a vehicle and provision information on a provider who provides a music supply to be used in the music class;

execute matching between the music class and the provider based on the holding information and the provision information that are acquired; and

determine procurement information to be notified to the provider according to a result of the matching.

A program according to an embodiment of the present disclosure causes an information processing apparatus to execute:

acquiring holding information on a music class to be held in a vehicle;

acquiring provision information on a provider who provides a music supply to be used in the music class;

executing matching between the music class and the provider based on the holding information and the provision information that are acquired; and

determining procurement information to be notified to the provider according to a result of the matching.

A program according to an embodiment of the present disclosure causes a terminal apparatus of a provider who provides a music supply to be used in a music class, to execute:

transmitting provision information on the provider who provides the music class to be held in a vehicle with the music supply, to an information processing apparatus; and

receiving procurement information determined by the information processing apparatus according to a result of matching between the music class and the provider executed by the information processing apparatus based on holding information on the music class and the provision information that are acquired by the information processing apparatus.

An information processing apparatus, a vehicle, an information processing system, and a program according to an embodiment of the present disclosure enables reduction of the burden on an owner, which accompanies ownership of a music supply in a music class.

### BRIEF DESCRIPTION OF THE DRAWINGS

In the accompanying drawings:

FIG. 1 is a configuration diagram illustrating a configuration of an information processing system including an information processing apparatus according to an embodiment of the present disclosure;

FIG. 2 is a functional block diagram illustrating a schematic configuration of each of an information processing apparatus, a first terminal apparatus, and a second terminal apparatus in FIG. 1;

FIG. 3 is a first diagram for explaining matching between a music class and a provider;

FIG. 4 is a second diagram for explaining matching between the music class and the provider;

FIG. 5 is a flowchart for explaining a first example of an information processing method executed by the information processing apparatus in FIG. 1;

FIG. 6 is a flowchart for explaining a second example of the information processing method executed by the information processing apparatus in FIG. 1;

FIG. 7 is a flowchart for explaining a third example of the information processing method executed by the information processing apparatus in FIG. 1; and

FIG. 8 is a flowchart for explaining a fourth example of the information processing method executed by the information processing apparatus in FIG. 1.

### DETAILED DESCRIPTION

An embodiment of the present disclosure will be described below, with reference to the drawings.

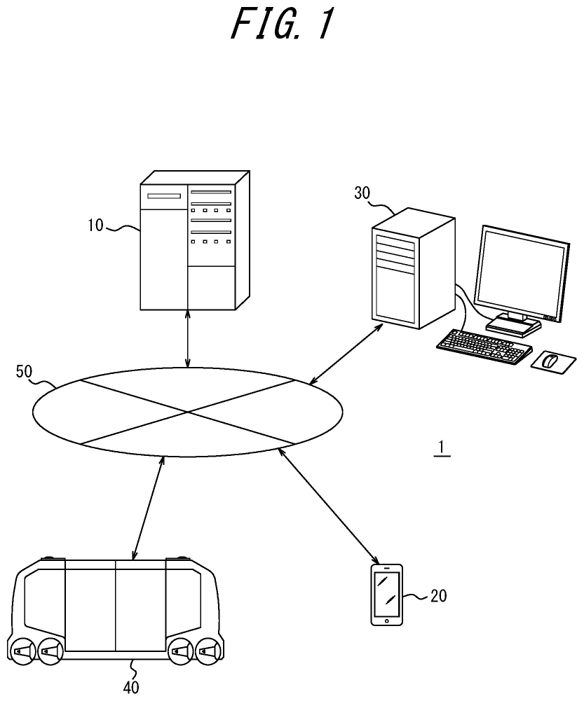

FIG. 1 is a configuration diagram illustrating a configuration of an information processing system 1 that includes an information processing apparatus 10 according to an embodiment of the present disclosure. Referring to FIG. 1, an outline of the information processing system 1 that includes the information processing apparatus 10 according to the embodiment of the present disclosure will be primarily described. In addition to the information processing apparatus 10, the information processing system 1 includes a first terminal apparatus 20 and a second terminal apparatus 30. For the sake of simplicity, FIG. 1 illustrates one of each of the first terminal apparatus 20, the second terminal apparatus 30, and a vehicle 40, but the number of first terminal apparatuses 20 and second terminal apparatuses 30 included in the information processing system 1, and vehicles 40 may be two or more.

Each of the information processing apparatus 10, the first terminal apparatus 20, and the second terminal apparatus 30 is connected to a network 50 that includes, for example, a mobile communication network, the Internet, and the like, together with the vehicle 40, in which a music class is held, so as to communicate with each other. At least part of the information processing system 1 is used for providing a mobility service. Each service provider can provide a mobility service such as a mobile music class, by using the vehicle 40. The number of instructors and students in a music class to be held in the vehicle 40 may be one, or may be two or more.

The information processing apparatus 10 is a single server apparatus or a plurality of server apparatuses that can communicate with each other. The information processing apparatus 10 is not limited to these, and may be any general purpose electronic device such as a personal computer (PC) or a smartphone, or may be any other electronic device that is dedicated to the information processing system 1.

The first terminal apparatus 20 is, for example, a general purpose electronic device such as a smartphone or a PC. The first terminal apparatus 20 is, for example, an electronic device used by a provider who provides the music class to be held in the vehicle 40 with a music supply. The first terminal apparatus 20 is not limited to these, and may be an electronic device that is dedicated to the information processing system 1. In this specification, the “music supply” includes, for example, a musical instrument or a musical score. The “provider” includes, for example, a retailer selling music supplies, a rental agent lending music supplies, or any other individual or organization which owns music supplies. The number of providers may be one, or may be two or more.

The second terminal apparatus 30 is, for example, a general purpose electronic device such as a PC or a smartphone. The second terminal apparatus 30 is, for example, an electronic device used by a member of staff of an operating company that operates the music class to be held in the vehicle 40. The second terminal apparatus 30 is not limited to these, and may be a single server apparatus used by the operating company, or a plurality of server apparatuses used by the operating company that can communicate with each other, or may be an electronic device that is dedicated to the information processing system 1.

The vehicle 40 is, for example, an automobile. The vehicle 40 is not limited to this, and may be any vehicle that a person can board to hold the music class in the vehicle 40. While the music class is held, the vehicle 40 may move, or may be stationary. The vehicle 40 is, for example, a vehicle that performs automated driving. The automated driving may include any level from Level 1 to Level 5 as defined by the Society of Automotive Engineers (SAE), for example, but is not limited to these, and may be defined in any way. The vehicle 40 is not limited to a vehicle that performs automated driving, and may be any vehicle driven by a driver.

The vehicle 40 procures music supplies to be used in the music class from one or more providers. For example, the vehicle 40 that is the same as the vehicle 40 in which a music class is to be held directly procures a music supply to be used in the music class from a provider. Without being limited to this, one or more vehicles 40 that are different from the vehicle 40 in which the music class is to be held may indirectly procure music supplies to be used in the music class from a provider, and deliver the music supplies to the vehicle 40 in which the music class is to be held. A corresponding type of the music supply to be procured by each vehicle 40 may be previously determined, or the vehicle 40 that is closest to the provider among vehicles 40 that are dispersed in respective areas may procure the music supplies from the provider.

As an outline of an embodiment, the information processing apparatus 10 acquires holding information on each music class to be held in the vehicle 40. In this specification, the “holding information” includes various information related to holding of a music class in the vehicle 40. The “holding information” includes, for example, a holding area, a start date and time, an end date and time, and details of a required music supply. The “details of a music supply” include, for example, the number of music supplies, the type of each music supply, and the grade of each music supply.

The information processing apparatus 10 acquires provision information on each provider who provides a music supply to be used in a corresponding music class. In this specification, the “provision information” includes various information related to provision, by a provider, of a music supply to a music class to be held in the vehicle 40. The “provision information” includes, for example, a provision location and a provision date and time that are desired by a provider, and details of a music supply that the provider desires to provide.

The information processing apparatus 10 executes matching between a music class and a provider based on the holding information and the provision information that are acquired, and determines procurement information to be notified to the provider according to the result of the matching. In this specification, “matching” means determining a certain music class and a certain provider for which the holding information and the provision information conform to each other, from a plurality of music classes and a plurality of providers, respectively. The “procurement information” includes various information required for the vehicle 40 to procure a music supply to be used in a music class from a provider. The “procurement information” includes, for example, a procurement location, a procurement date and time, and details of a music supply, regarding procurement of a music supply.

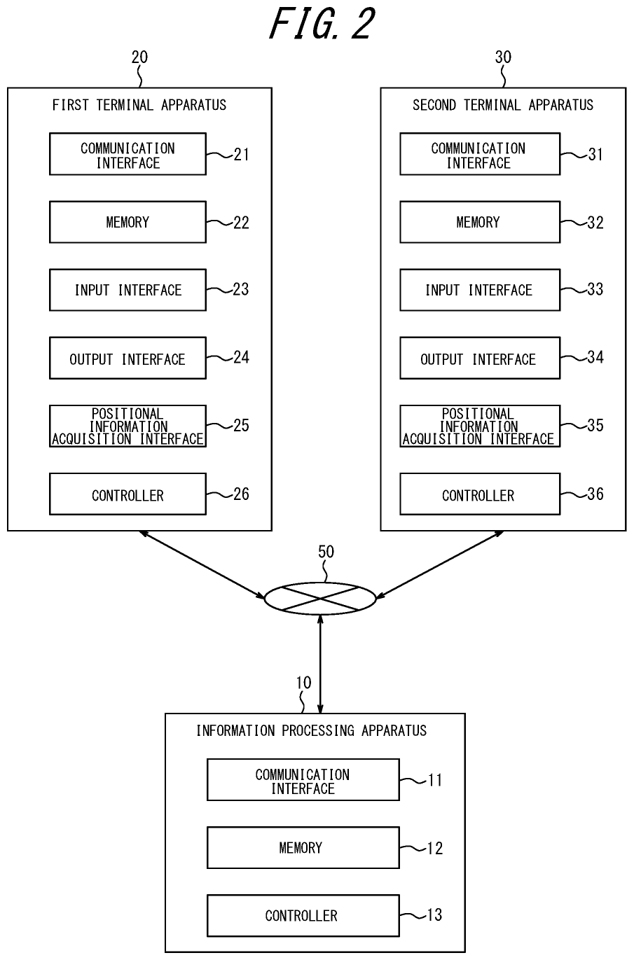

Next, referring to FIG. 2, a configuration of each apparatus included in the information processing system 1 will be primarily described. FIG. 2 is a functional block diagram illustrating a schematic configuration of each of the information processing apparatus 10, the first terminal apparatus 20, and the second terminal apparatus 30 in FIG. 1.

As illustrated in FIG. 2, the first terminal apparatus 20 includes a communication interface 21, a memory 22, an input interface 23, an output interface 24, a positional information acquisition interface 25, and a controller 26.

The communication interface 21 includes a communication module connected to the network 50. For example, the communication interface 21 may include a communication module compliant with mobile communication standards such as the 4th generation (4G) and the 5th generation (5G) standards. In an embodiment, the first terminal apparatus 20 is connected to the network 50 via the communication interface 21. The communication interface 21 transmits and receives various information via the network 50.

The memory 22 is, for example, a semi-conductor memory, a magnetic memory, an optical memory, or the like, but is not limited to these. The memory 22 may function as, for example, a main memory, an auxiliary memory, or a cache memory. The memory 22 stores any information used in operation of the first terminal apparatus 20. For example, the memory 22 may store a system program, an application program, various types of information received by the communication interface 21, and the like. Information stored in the memory 22 may be updated with, for example, information received from the network 50 via the communication interface 21.

The input interface 23 includes at least one input interface for detecting user input to acquire input information based on an operation by a user. The input interface 23 is, for example, a physical key, a capacitive key, a touch screen integrally provided with a display of the output interface 24, a microphone for receiving audio input, or the like, but is not limited to these.

The output interface 24 includes at least one output interface for outputting information to notify information to the user. The output interface 24 is, for example, a display for outputting the information in the form of an image, a speaker for outputting the information in the form of audio, or the like, but is not limited to these.

The positional information acquisition interface 25 includes at least one receiver compliant with a satellite positioning system. For example, the positional information acquisition interface 25 may include a Global Positioning System (GPS) receiver. The positional information acquisition interface 25 acquires a measured value of the position of the first terminal apparatus 20 as positional information. The positional information includes, for example, an address, a latitude, a longitude, and an altitude. The positional information acquisition interface 25 may continuously acquire, or may periodically or non-periodically acquire the positional information for the first terminal apparatus 20.

The controller 26 includes at least one processor. The “processor” is a general purpose processor or a dedicated processor that is dedicated to specific processing in an embodiment but is not limited to these. The controller 26 is connected to each component included in the first terminal apparatus 20 so as to communicate with each component, and controls operation of the entire first terminal apparatus 20.

When the input interface 23 detects an operation by the user as a provider who requests registration of provision information, the controller 26 displays an input screen indicating items required for registration of the provision information, using the output interface 24. The items required for registration of the provision information include, for example, items of a provision location and a provision date and time that are desired by the provider, and details of a music supply that the provider desires to provide. The controller 26 acquires input information regarding these items that the user inputs by operating the input interface 23. The controller 26 transmits the acquired input information as the provision information to the information processing apparatus 10 via the communication interface 21 and the network 50.

The controller 26 receives, from the information processing apparatus 10 via the network 50 and the communication interface 21, procurement information according to a result of the matching between a music class and a provider executed by the information processing apparatus 10. The provider understands the details of the music supply to be provided to the music class, the procurement location, and the procurement date and time, from the procurement information notified by the first terminal apparatus 20. The provider provides the vehicle 40, which is navigated to the notified procurement location, with a required music supply at the procurement location at the notified procurement date and time.

For example, when the input interface 23 detects an operation by the user as a provider who requests an evaluation of an instructor or a student in a music class, the controller 26 displays an input screen indicating items required for the evaluation of the instructor or the student, using the output interface 24. The items required for the evaluation include, for example, items of an evaluation target selected from among the instructor and the student, an evaluation index such as a rank and a score for the selected evaluation target, and an evaluation comment on the evaluation target. The controller 26 acquires input information regarding these items that the user inputs by operating the input interface 23. The controller 26 transmits the acquired input information as instructor evaluation information or student evaluation information indicating the result of the evaluation by the provider of another from among the instructor and the student of the music class and the provider, to the information processing apparatus 10 via the communication interface 21 and the network 50.

In this specification, the “evaluation information” includes, for example, an evaluation target, an evaluation index such as a rank and a score of the evaluation target, and an evaluation comment on the evaluation target. The term “student evaluation information” means evaluation information indicating a result of an evaluation of a student of a music class by an instructor of the music class or a provider. For example, “student evaluation information” means evaluation information indicating a result of an evaluation of a student of a music class by an instructor of the music class regarding playing in the music class. For example, “student evaluation information” means evaluation information indicating a result of an evaluation, by a provider, of the quality of an evaluation comment received from a student after the provider checks the evaluation comment made by the student on the provider.

The term “instructor evaluation information” means evaluation information indicating a result of an evaluation of an instructor of a music class by a student of the music class or a provider. For example, “instructor evaluation information” means evaluation information indicating a result of an evaluation of an instructor of a music class by a student of the music class regarding playing instructions in the music class. For example, “instructor evaluation information” means evaluation information indicating a result of an evaluation, by a provider, of the quality of an evaluation comment received from an instructor after the provider checks the evaluation comment made by the instructor on the provider.

The term “provider evaluation information” means evaluation information indicating a result of an evaluation of a provider by an instructor or a student of a music class. For example, “provider evaluation information” means evaluation information indicating a result of an evaluation of a provider, by an instructor or a student of a music class, regarding the quality of a music supply provided by the provider to the music class.

The controller 26 receives provider evaluation information from the information processing apparatus 10 via the network 50 and the communication interface 21. When the input interface 23 detects an operation by the user of the provider, the controller 26 outputs the received evaluation information to the output interface 24.

Next, the configuration of the second terminal apparatus 30 included in the information processing system 1 will be primarily described. As illustrated in FIG. 2, the second terminal apparatus 30 includes a communication interface 31, a memory 32, an input interface 33, an output interface 34, a positional information acquisition interface 35, and a controller 36. With respect to the configuration of each component included in the second terminal apparatus 30, the same explanation as the corresponding component included in the above described first terminal apparatus 20 applies.

When the input interface 33 detects an operation by the user as a member of staff of an operating company who requests registration of holding information, the controller 36 displays an input screen indicating items required for registration of the holding information, using the output interface 34. The items required for registration of the holding information include, for example, items of a holding area, a start date and time, an end date and time, and details of a required music supply. The controller 36 acquires input information regarding these items that the member of staff inputs by operating the input interface 33. The controller 36 transmits the acquired input information as the holding information to the information processing apparatus 10 via the communication interface 31 and the network 50.

In addition to the holding information, the controller 36 also transmits participant information on participants including an instructor and a student participating in a music class, to the information processing apparatus 10 via the communication interface 31 and the network 50. In this specification, “participant information” includes, for example, an address of each participant, a participation start date and time, and a participation end date and time. The participant information is acquired by the controller 36 by, for example, being transmitted from any terminal apparatus used by the participants to the second terminal apparatus 30.

The controller 36 receives, from the information processing apparatus 10 via the network 50 and the communication interface 31, pickup information for the vehicle 40 to pick up the participants of the music class, which is determined by the information processing apparatus 10 based on the participant information. In this specification, “pickup information” includes, for example, a pickup location, a pickup route, and a pickup date and time that are optimized, according to the participant information, for the vehicle 40 to pick up the participants. The controller 36 notifies the participants of the pickup information received from the information processing apparatus 10, as required. For example, the participants understand the pickup location and the pickup date and time of the vehicle 40 in which the music class is held, based on the pickup information transmitted from the second terminal apparatus 30 to any terminal apparatus used by the participants.

The controller 36 receives, from a terminal apparatus used by an instructor, for example, student evaluation information regarding playing in a music class, or provider evaluation information regarding the quality of a music supply provided by a provider to the music class. The controller 36 transmits the received evaluation information as evaluation information indicating a result of an evaluation by the instructor of another from among the instructor and the student of the music class and the provider, to the information processing apparatus 10 via the communication interface 31 and the network 50.

The controller 36 receives, from a terminal apparatus used by a student, for example, instructor evaluation information regarding playing instructions in a music class, or provider evaluation information regarding the quality of a music supply provided by a provider to the music class. The controller 36 transmits the received evaluation information as evaluation information indicating a result of an evaluation by the student of another from among the instructor and the student of the music class and the provider, to the information processing apparatus 10 via the communication interface 31 and the network 50.

The controller 36 receives, from the information processing apparatus 10 via the network 50 and the communication interface 31, for example, instructor evaluation information indicating a result of an evaluation by a provider, of the quality of an evaluation comment received from an instructor. The controller 36 transmits the received evaluation information to a terminal apparatus used by the instructor, as required. For example, upon receiving instructor evaluation information indicating a result of an evaluation of the instructor by a student regarding playing instructions in the music class, from a terminal apparatus used by the student, the controller 36 may transmit the received evaluation information to the terminal apparatus used by the instructor, as required.

The controller 36 receives, from the information processing apparatus 10 via the network 50 and the communication interface 31, for example, student evaluation information indicating a result of an evaluation by a provider, of the quality of an evaluation comment received from a student. The controller 36 transmits the received evaluation information to a terminal apparatus used by the student, as required. For example, upon receiving student evaluation information indicating a result of an evaluation of the student by an instructor regarding playing in the music class, from a terminal apparatus used by the instructor, the controller 36 may transmit the received evaluation information to the terminal apparatus used by the student, as required.

In the vehicle 40, for example, vehicle control based on control information received from the information processing apparatus 10 is performed. The vehicle control is, for example, automated driving control for navigating the vehicle 40 to each pickup location, at which a corresponding participant is to be picked up, according to a pickup route based on the above mentioned pickup information determined by the information processing apparatus 10, but is not limited to this. The vehicle control may be automated driving control for navigating the vehicle 40 to a procurement location for procuring a music supply to be used in a music class from a provider, based on procurement route information, which will be described later.

Next, the configuration of the information processing apparatus 10 included in the information processing system 1 will be primarily described. As illustrated in FIG. 2, the information processing apparatus 10 includes a communication interface 11, a memory 12, and a controller 13.

The communication interface 11 includes a communication module connected to the network 50. For example, the communication interface 11 may include a communication module compliant with mobile communication standards such as the 4G and the 5G standards. In an embodiment, the information processing apparatus 10 is connected to the network 50 via the communication interface 11. The communication interface 11 transmits and receives various information via the network 50.

The memory 12 is, for example, a semi-conductor memory, a magnetic memory, an optical memory, or the like, but is not limited to these. The memory 12 may function as, for example, a main memory, an auxiliary memory, or a cache memory. The memory 12 stores any information used in operation of the information processing apparatus 10. For example, the memory 12 may store a system program, an application program, various types of information received by the communication interface 11, and the like. Information stored in the memory 12 may be updated with, for example, information received from the network 50 via the communication interface 11.

The controller 13 includes at least one processor. The “processor” is a general purpose processor or a dedicated processor that is dedicated to specific processing in an embodiment but is not limited to these. The controller 13 is connected to each component included in the information processing apparatus 10 so as to communicate with each component, and controls operation of the entire information processing apparatus 10.

The controller 13 receives holding information on each music class to be held in the vehicle 40 from the second terminal apparatus 30 via the network 50 and the communication interface 11. The controller 13 receives provision information on each provider who provides a music supply to be used in a corresponding music class, from each first terminal apparatus 20 via the network 50 and the communication interface 11. The controller 13 executes matching between a music class and a provider based on the holding information and the provision information that are received. The controller 13 determines procurement information to be notified to the provider according to the result of the matching. The controller 13 transmits the determined procurement information to the first terminal apparatus 20 of the provider related to the procurement information via the communication interface 11 and the network 50.

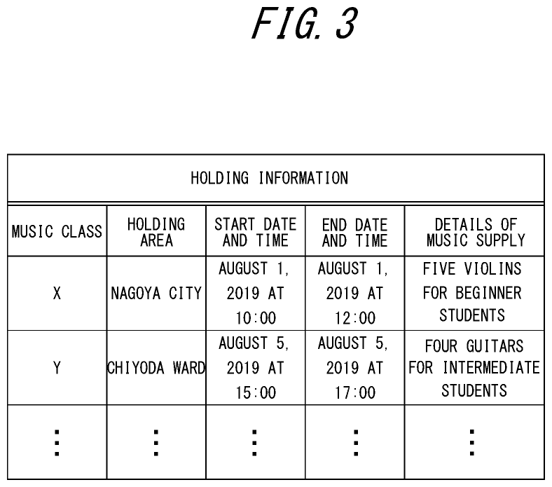

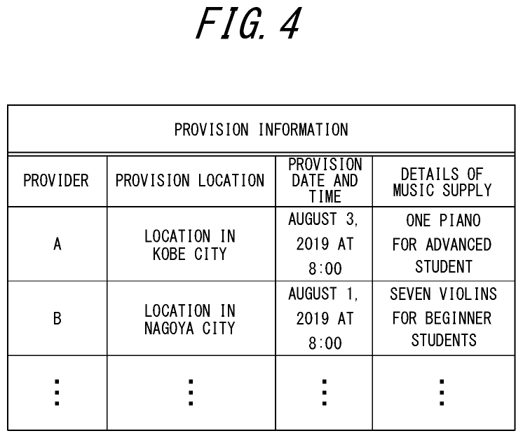

FIG. 3 is a first diagram for explaining matching between a music class and a provider. FIG. 4 is a second diagram for explaining the matching between the music class and the provider. Referring to FIGS. 3 and 4, examples of a matching process and a determining process for procurement information executed by the controller 13 will be described in more detail.

The controller 13 acquires holding information on music class X to be held in the vehicle 40. According to the holding information on music class X, the holding area is Nagoya City. Similarly, the start date and time, and the end date and time are Aug. 1, 2019 at 10:00 and 12:00, respectively. The details of the music supplies required in music class X are five violins for beginner students.

The controller 13 acquires holding information on music class Y to be held in the vehicle 40. According to the holding information on music class Y, the holding area is Chiyoda Ward. Similarly, the start date and time, and the end date and time are Aug. 5, 2019 at 15:00 and 17:00, respectively. The details of the music supplies required in music class Y are four guitars for intermediate students.

In addition to the holding information on music classes X and Y, the controller 13 may further acquire holding information on other music classes. The holding information is not limited to the contents illustrated in FIG. 3, and may include any content. For example, the number of types of music supplies required by one music class is not limited to one, and may be two or more. For example, a musical score in addition to a musical instrument, or multiple types of musical instruments may be included as the types of music supplies required by one music class.

The controller 13 acquires provision information on provider A who provides a music supply to be used in a music class. According to the provision information on provider A, the provision location desired by provider A is a predetermined location in Kobe City. Similarly, the provision date and time desired by provider A is Aug. 3, 2019 at 8:00, and the details of the music supply are one piano for advanced students.

The controller 13 acquires provision information on provider B who provides music supplies to be used in a music class. According to the provision information on provider B, the provision location desired by provider B is a predetermined location in Nagoya City. Similarly, the provision date and time desired by provider B is Aug. 1, 2019 at 8:00, and the details of the music supplies are seven violins for beginner students.

In addition to the provision information on providers A and B, the controller 13 may further acquire provision information on other providers. The provision information is not limited to the contents illustrated in FIG. 4, and may include any content. For example, the number of types of music supplies that one provider desires to provide is not limited to one, and may be two or more. For example, a musical score in addition to a musical instrument, or multiple types of musical instruments may be included as the types of music supplies that one provider desires to provide.

In this situation, the holding area, the start date and time, and the details of the music supplies for music class X correspond to the provision location, the provision date and time, and the details of the music supplies for provider B, respectively. Therefore, the controller 13 extracts the holding information associated with music class X and the provision information associated with provider B, from the holding information on the music classes and the provision information on the providers that are acquired, thereby executing matching between music class X and provider B.

According to the result of such matching, the controller 13 may determine the procurement location regarding procurement of the music supplies to be, for example, the location in Nagoya City desired by provider B as the provision location, or the vicinity thereof. Similarly, the controller 13 may determine the procurement date and time regarding the procurement of the music supplies to be, for example Aug. 1, 2019 at 8:00, which provider B desires as the provision date and time, or the vicinity thereof. Similarly, the controller 13 may determine the details of the music supplies regarding the procurement of the music supplies to be, for example, five violins for beginner students, which will actually be required in music class X, out of seven violins for beginner students that provider B desires to provide.

The controller 13 receives participant information on participants including an instructor and a student participating in a music class, from the second terminal apparatus 30 via the network 50 and the communication interface 11. The controller 13 determines pickup information for the vehicle 40 to pick up the participants of the music class, based on the received participant information. In addition, the controller 13 determines, as procurement route information, a route for navigating the vehicle 40 to the location at which a music supply is to be procured, the location being included in the determined procurement information. The controller 13 transmits the determined pickup information to the second terminal apparatus 30 and the vehicle 40 via the communication interface 11 and the network 50. The controller 13 transmits the determined procurement route information along with the procurement information to the vehicle 40 via the communication interface 11 and the network 50.

The controller 13 acquires evaluation information indicating a result of an evaluation by one of another from among the instructor and the student of the music class and a provider. For example, the controller 13 receives instructor evaluation information or student evaluation information from the first terminal apparatus 20 of the provider via the network 50 and the communication interface 11. For example, the controller 13 receives student evaluation information or provider evaluation information from a terminal apparatus used by the instructor via the second terminal apparatus 30, the network 50, and the communication interface 11. For example, the controller receives instructor evaluation information or provider evaluation information from a terminal apparatus used by the student via the second terminal apparatus 30, the network 50, and the communication interface 11.

The controller 13 may determine, for example, details of a music supply required in the music class included in the holding information, based on the acquired student evaluation information. For example, when the controller 13 determines that an evaluation rank in the acquired student evaluation information is lower than a predetermined rank, the controller 13 may determine the grade of a musical instrument required in the music class to be lower than a predetermined grade. For example, when the controller 13 determines that the evaluation rank in the acquired student evaluation information is equal to or higher than the predetermined rank, the controller 13 may determine the grade of the musical instrument required in the music class to be equal to or higher than the predetermined grade. Similarly, the controller 13 may determine the details of the music supply required in the music class by associating an evaluation score, an evaluation comment, and the like in the acquired student evaluation information, with the grade of a musical instrument.

The controller 13 may determine, for example, a tuition fee to be paid by the student to the operating company for taking the music class, based on the acquired student evaluation information. For example, when the controller 13 determines that the evaluation rank in the acquired student evaluation information is lower than a predetermined rank, the controller 13 may determine the tuition fee to be higher than a predetermined amount. For example, when the controller 13 determines that the evaluation rank in the acquired student evaluation information is equal to or higher than the predetermined rank, the controller 13 may determine the tuition fee to be equal to or lower than the predetermined amount. Similarly, the controller 13 may determine the tuition fee to be paid by the student to the operating company, by associating the evaluation score, the evaluation comment, and the like in the acquired student evaluation information, with the tuition fee.

The controller 13 may determine, for example, a payment to be obtained by the instructor from the operating company for giving the playing instructions in the music class, based on the acquired instructor evaluation information. For example, when the controller 13 determines that an evaluation rank in the acquired instructor evaluation information is lower than a predetermined rank, the controller 13 may determine the payment to be lower than a predetermined amount. For example, when the controller 13 determines that the evaluation rank in the acquired instructor evaluation information is equal to or higher than the predetermined rank, the controller 13 may determine the payment to be equal to or higher than the predetermined amount. Similarly, the controller 13 may determine the payment to be obtained by the instructor from the operating company, by associating an evaluation score, an evaluation comment, and the like in the acquired instructor evaluation information, with the payment.

The controller 13 may determine, for example, a provision fee to be paid by the operating company that operates the music class to the provider for the music supply, based on the acquired provider evaluation information. In this specification, the “provision fee” includes, for example, a purchase fee or a rental fee. For example, when the controller 13 determines that an evaluation rank in the acquired provider evaluation information is lower than a predetermined rank, the controller 13 may determine the provision fee for the music supply to be lower than a predetermined amount. For example, when the controller 13 determines that the evaluation rank in the acquired provider evaluation information is equal to or higher than the predetermined rank, the controller 13 may determine the provision fee for the music supply to be equal to or higher than the predetermined amount. Similarly, the controller 13 may determine the provision fee for the music supply to be paid by the operating company to the provider, by associating an evaluation score, an evaluation comment, and the like in the acquired provider evaluation information, with the provision fee for the music supply.

The controller 13 transmits all of the above mentioned determination information determined based on the evaluation information, to the second terminal apparatus 30 via the communication interface 11 and the network 50. In addition, the controller 13 transmits information regarding the provision fee for the music supply to be paid by the operating company to the provider, which is determined based on the provider evaluation information, to the first terminal apparatus 20 via the communication interface 11 and the network 50.

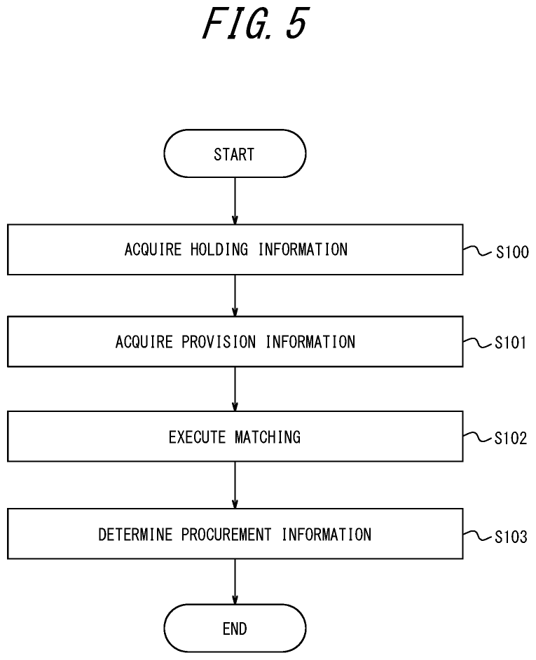

Next, an information processing method executed by the controller 13 of the information processing apparatus 10 according to an embodiment will be described, referring to FIGS. 5 to 8. FIG. 5 is a flowchart for explaining a first example of the information processing method executed by the information processing apparatus 10 in FIG. 1.

In step S100, the controller 13 acquires holding information on each music class to be held in the vehicle 40.

In step S101, the controller 13 acquires provision information on each provider who provides a music supply to be used in a corresponding music class.

In step S102, the controller 13 executes matching between a music class and a provider based on the holding information acquired in step S100 and the provision information acquired in step S101.

In step S103, the controller 13 determines procurement information to be notified to the provider according to the result of the matching in step S102.

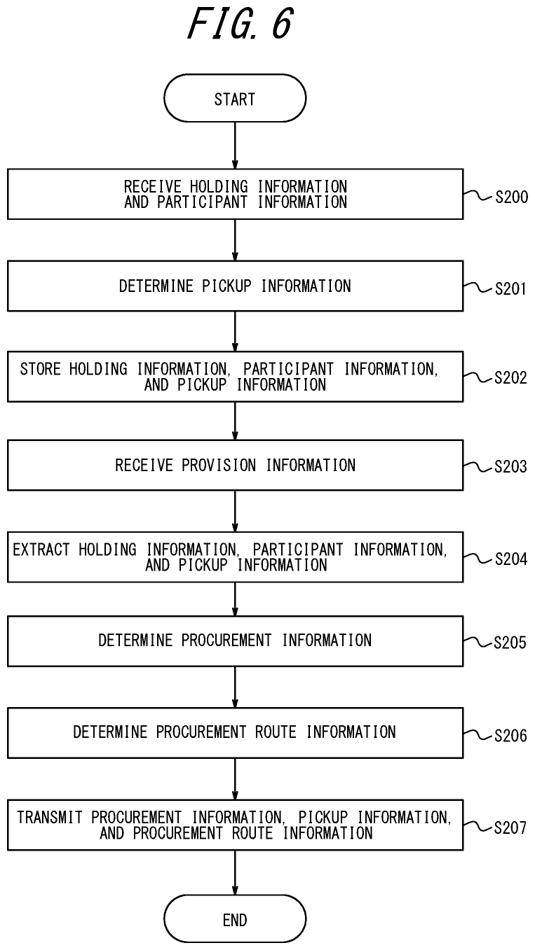

FIG. 6 is a flowchart for explaining a second example of the information processing method executed by the information processing apparatus 10 in FIG. 1. The flowchart given in FIG. 6 illustrates the control flow of the flowchart given in FIG. 5 in more detail. The flowchart in FIG. 6 illustrates a control flow performed when execution of the matching between the music class and the provider is triggered by transmittal of the provision information to the information processing apparatus 10 by the provider using the first terminal apparatus 20.

In step S200, the controller 13 receives the holding information on each music class to be held in the vehicle 40 and participant information related to the holding information, from the second terminal apparatus 30 via the network 50 and the communication interface 11.

In step S201, the controller 13 determines pickup information for the vehicle 40 to pick up participants including an instructor and a student of each music class, based on the participant information on the participants.

In step S202, the controller 13 stores the holding information and the participant information received in step S200 and the pickup information determined in step S201, in the memory 12.

In step S203, the controller 13 receives the provision information from the first terminal apparatus 20 of the provider via the network 50 and the communication interface 11.

In step S204, the controller 13 executes the matching by extracting a series of information including the holding information, the participant information, and the pickup information corresponding to the provision information received in step S203, from the series of information associated with the music classes.

In step S205, the controller 13 determines the procurement information to be notified to the provider according to the result of the matching in step S204.

In step S206, the controller 13 determines, as procurement route information, a route for navigating the vehicle 40 to the location at which the music supply is to be procured, the location being included in the procurement information determined in step S205,

In step S207, the controller 13 transmits the procurement information determined in step S205 to the first terminal apparatus 20 and the vehicle 40 via the communication interface 11 and the network 50. The controller 13 transmits the pickup information determined in step S201 to the second terminal apparatus 30 and the vehicle 40 via the communication interface 11 and the network 50. The controller 13 transmits the procurement route information determined in step S206 to the vehicle 40 via the communication interface 11 and the network 50.

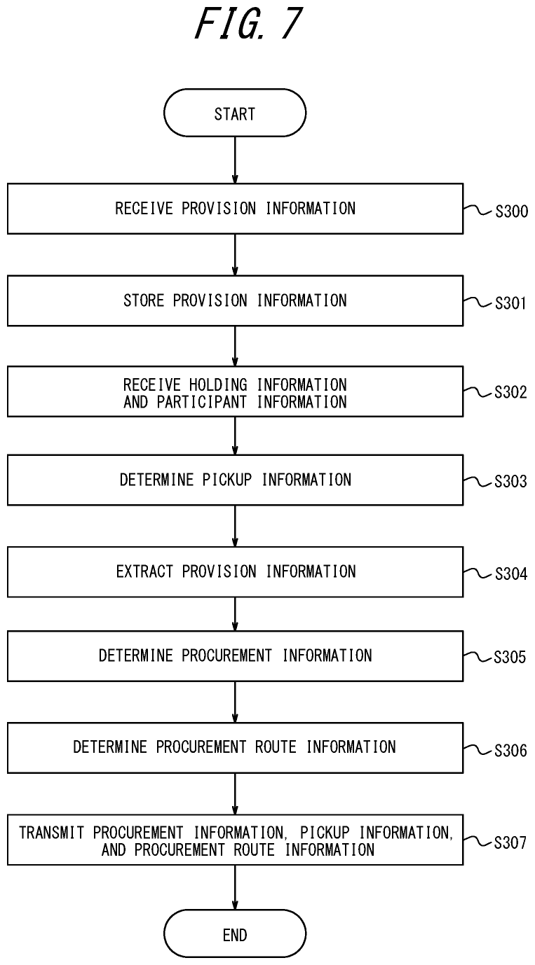

FIG. 7 is a flowchart for explaining a third example of the information processing method executed by the information processing apparatus 10 in FIG. 1. The flowchart given in FIG. 7 illustrates the control flow of the flowchart given in FIG. 5 in more detail. The flowchart in FIG. 7 illustrates a control flow performed when execution of the matching between the music class and the provider is triggered by transmittal of the holding information to the information processing apparatus 10 by a member of staff of an operating company that operates the music class using the second terminal apparatus 30.

In step S300, the controller 13 receives the provision information on each provider who provides a corresponding music class with the music supply, from the first terminal apparatus 20 of each provider via the network 50 and the communication interface 11.

In step S301, the controller 13 stores the provision information received in step S300 in the memory 12.

In step S302, the controller 13 receives the holding information on a music class to be held in the vehicle 40 and participant information related to the holding information, from the second terminal apparatus 30 via the network 50 and the communication interface 11.

In step S303, the controller 13 determines pickup information for the vehicle 40 to pick up participants including an instructor and a student of the music class, based on the participant information on the participants.

In step S304, the controller 13 executes the matching by extracting the provision information corresponding to the holding information and the participant information related to the holding information that are received in step S302, from the provision information associated with each provider.

In step S305, the controller 13 determines the procurement information to be notified to a provider according to the result of matching in step S304.

In step S306, the controller 13 determines, as procurement route information, a route for navigating the vehicle 40 to the location at which the music supply is to be procured, the location being included in the procurement information determined in step S305.

In step S307, the controller 13 transmits the procurement information determined in step S305 to the first terminal apparatus 20 and the vehicle 40 via the communication interface 11 and the network 50. The controller 13 transmits the pickup information determined in the step S303 to the second terminal apparatus 30 and the vehicle 40 via the communication interface 11 and the network 50. The controller 13 transmits the procurement route information determined in step S306 to the vehicle 40 via the communication interface 11 and the network 50.

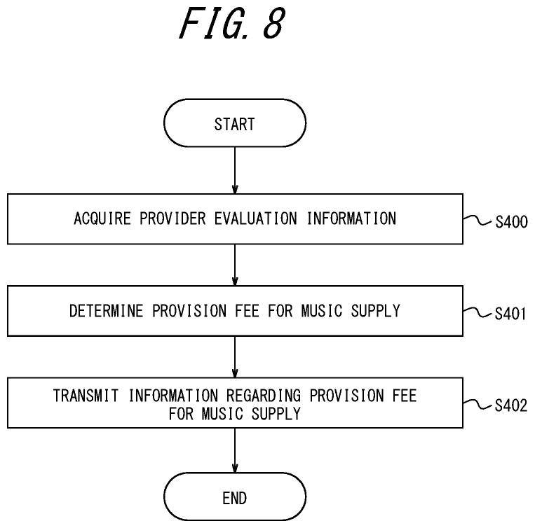

FIG. 8 is a flowchart for explaining a fourth example of the information processing method executed by the information processing apparatus 10 in FIG. 1. The flowchart given in FIG. 8 illustrates a control flow that is executed when the information processing apparatus 10 receives evaluation information indicating a result of an evaluation of the provider by the instructor or the student of the music class from the second terminal apparatus 30 via the network 50 and the communication interface 11, for example, after the music class has been held.

In step S400, the controller 13 acquires the evaluation information indicating the result of the evaluation of the provider by the instructor or the student of the music class.

In step S401, the controller 13 determines a provision fee to be paid by the operating company that operates the music class to the provider for the music supply based on the provider evaluation information acquired in step S400.

In step S402, the controller 13 transmits information regarding the provision fee for the music supply determined in step S401 to the first terminal apparatus 20 and the second terminal apparatus 30 via the communication interface 11 and the network 50. The first terminal apparatus 20 receives the information regarding the provision fee for the music supply from the information processing apparatus 10 via the network 50 and the communication interface 21. The second terminal apparatus 30 receives the information regarding the provision fee for the music supply from the information processing apparatus 10 via the network 50 and the communication interface 31.

FIG. 8 illustrates a control flow of the information processing apparatus 10 relating to the provision fee for the music supply in the above described determination information that is determined based on the evaluation information. A similar control flow applies to other determination information. In this case, the controller 36 of the second terminal apparatus 30 may transmit other determination information received from the information processing apparatus 10 to a terminal apparatus used by the instructor and/or a terminal apparatus used by the student, as required.

According to the above mentioned embodiment, it is possible to reduce the burden on an owner, which accompanies ownership of a music supply in a music class. For example, since the vehicle 40 is used for holding a music class and procuring a music supply, the procurement location and the procurement date and time at which the music supply is to be procured can be easily adjusted depending on the moving time and the moving place of the vehicle 40. That is, the limitations on the procurement location and the procurement date and time at which the music supply is to be procured from a provider are sufficiently relaxed, and thus the potential for matching between the music class and the provider is improved. As a result, the music supply owned by the provider is effectively provided to the music class. In this way, the service regarding the music supply procurement and the service regarding the music class are successively associated, thereby enabling the operating company to effectively utilize, without owning all music supplies by itself, a music supply owned by the provider in the music class. Therefore, the operating company does not need to own at least some of the music supplies, and the burden which accompanies ownership of the music supplies can be reduced. By the above, the operating company can perform operation of the music class smoothly.

As in the control flow illustrated in FIG. 6, the execution, by the information processing apparatus 10, of the matching between the music class and the provider is triggered by transmittal of the provision information to the information processing apparatus 10 by the provider using the first terminal apparatus 20, thereby selecting in real time the most appropriate music class in accordance with the provision information on the provider from the plurality of music classes stored in the information processing apparatus 10. For example, at the point when the provider falls into a state of excessively owning music supplies, the provider can search on demand for the most appropriate music class in accordance with the provision information. Therefore, the utilization efficiency of the music supply owned by the provider is improved. In addition, the convenience for the provider who uses the information processing system 1 which includes the information processing apparatus 10 is improved. Further, the provision fee for the music supply is paid by the operating company that operates the music class, to thereby improve the profit for the provider obtained by provision of the music supply. By the above, satisfaction of the provider is improved, and the mechanism for providing the music supply from the provider becomes effective.

As in the control flow of FIG. 7, the execution, by the information processing apparatus 10, of the matching between the music class and the provider is triggered by transmittal of the holding information to the information processing apparatus 10 by the member of staff of the operating company that operates the music class using the second terminal apparatus 30, thereby selecting in real time the most appropriate provider in accordance with the holding information on the music class from the plurality of providers stored in the information processing apparatus 10. Therefore, the convenience for the operating company that uses the information processing system 1 which includes the information processing apparatus 10 is improved. The operating company can find with more certainty a provider who is able to provide a music supply required in a music class, and can run the music class smoothly.

By acquiring the evaluation information indicating the result of the evaluation by one of another from among the instructor and the student of the music class and the provider, the information processing apparatus 10 can determine various information related to the evaluation information for the instructor, the student, and the provider. Utilizing the various determined information in the service regarding the music class and the service regarding the procurement of the music supply improves the attractiveness of these services. Thus, the frequency of use of these services by the instructor, the student, and the provider is increased. As a result, the profit for the operating company obtained by operation of the music class and the profit for the provider obtained by the provision of music supply are improved.

The information processing apparatus 10 determines the details of the music supply required in the music class included in the holding information based on the acquired student evaluation information, thereby enabling the operating company, which receives notification of the determined details of the music supply, to hold the music class most appropriate for the playing level of the student. The student who takes such a music class can also receive playing instructions most appropriate for the playing level of the student. Therefore, the attractiveness of the service regarding the music class is improved, and the frequency of use of the service by the student is increased.

The information processing apparatus 10 determines the tuition fee to be paid by the student to the operating company for taking the music class, based on the acquired student evaluation information, thereby enabling the operating company, which receives notification of the determined tuition fee, to present to the student, the tuition fee most appropriate for the playing level of the student. The student who takes the music class also attempts to improve his/her playing level in order to lower the tuition fee, and thus his/her motivation for playing is increased. Therefore, the attractiveness of the service regarding the music class is improved, and the frequency of use of the service by the student is increased. In addition, the student attempts to seriously give an evaluation comment for the provider regarding the provided music supply, in order to lower the tuition fee. Thus, the quality of the evaluation comment to be made is improved. As a result, the service regarding a series of music supply procurement and the service regarding the music class become more attractive, and the frequency of use of these services by the instructor, the student, and the provider is increased.

The information processing apparatus 10 determines the payment to be obtained by the instructor from the operating company for giving the playing instructions in the music class, based on the acquired instructor evaluation information, thereby enabling the operating company, which receives notification of the determined payment, to pay to the instructor, the payment most appropriate for the instruction level of the instructor. The instructor who gives the playing instructions in the music class also attempts to improve his/her instruction level in order to raise the payment, and thus his/her motivation for giving the playing instructions is increased. Therefore, the attractiveness of the service regarding the music class is improved, and the frequency of use of the service by the instructor is increased. In addition, the instructor attempts to seriously give an evaluation comment for the provider regarding the provided music supply, in order to raise the payment. Thus, the quality of the evaluation comment to be made is improved. As a result, the service regarding a series of music supply procurement and the service regarding the music class become more attractive, and the frequency of use of these services by the instructor, the student, and the provider is increased.

The information processing apparatus 10 determines the provision fee to be paid by the operating company that operates the music class to the provider for the music supply, based on the acquired provider evaluation information, thereby enabling the operating company, which receives notification of the determined provision fee for the music supply, to present to the provider, for example, the provision fee most appropriate for the quality of the music supply provided by the provider. The provider who provides the music supply also attempts to provide a higher quality music supply in order to raise the provision fee. Thus, the quality of the music supply to be used in the music class is improved. As a result, the service regarding a series of music supply procurement and the service regarding the music class become more attractive, and the frequency of use of these services by the instructor, the student, and the provider is increased.

The information processing apparatus 10 determines the pickup information based on the participant information, thereby enabling the vehicle 40 to pick up the instructor and student at the most appropriate times and places via the most appropriate route, for example, with automated driving. In addition, the information processing apparatus 10 determines the route for navigating the vehicle 40 to the determined location at which the music supply is to be procured, thereby enabling the vehicle 40 to move to the location at which the music supply is to be procured via the most appropriate route, for example, with automated driving.

The music class is held in the vehicle 40, thereby ensuring the privacy of the participants participating in the music classes. Thus, the reticence of the participants to participate in the music class is reduced. The music class is held in the vehicle 40, thereby enabling reduction of noise emitted to the surroundings of the vehicle 40 in which the music class is held.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each configuration, each step, or the like, may be rearranged without logical inconsistency, and a plurality of configurations, steps, or the like can be combined into one, or divided.

For example, in the embodiment described above, one or some processing operations executed in the information processing apparatus 10 may be executed in the first terminal apparatus 20 and/or the second terminal apparatus 30. At least one or some processing operations executed in the first terminal apparatus 20 and/or the second terminal apparatus 30 may be executed in the information processing apparatus 10.

For example, a configuration in which a general purpose electronic device such as a smartphone, a computer, or the like may be caused to function as the information processing apparatus 10 according to the embodiment described above is possible. Specifically, a program in which processes for realizing the functions of the information processing apparatus 10 or the like according to the embodiment are written may be stored in a memory of the electronic device, and the program may be read and executed by a processor of the electronic device. Accordingly, the disclosure according to an embodiment can also be implemented as a program executable by a processor. Alternatively, the disclosure according to an embodiment can also be implemented as a non-transitory computer readable medium storing a program executable by a single processor or a plurality of processors to cause the information processing apparatus 10, the first terminal apparatus 20, or the like according to the embodiment to execute the functions. It is to be understood that these are also included within the scope of the present disclosure.

For example, in the embodiment described above, the vehicle 40 has been described as an automated driving vehicle, but is not limited thereto. The vehicle 40 may not be an automated driving vehicle. In a vehicle 40, which is not an automated driving vehicle, routes based on the pickup information and the procurement route information that are received may be output to the driver, and driving along each route may be assisted.

For example, the information processing apparatus 10 described in the above embodiment may be mounted in the vehicle 40. In this case, the information processing apparatus 10 may directly perform information communication with the vehicle 40 without using the network 50. The information processing system 1 may not include the first terminal apparatus 20 and the second terminal apparatus 30, and the information processing apparatus 10 mounted in the vehicle 40 may execute the above described acquisition and notification of the information using any input interface and output interface provided in the vehicle 40. An electronic control unit (ECU) mounted in the vehicle 40 may function as the controller 13.

For example, in the embodiment described above, the music class has been described as being hosted by the operating company, but is not limited thereto. The music class may be hosted by at least one of the participants including the instructor and the student participating in the music class. In this case, at least one of the participants including the instructor and the student may provide the holding information on each music class to be held in the vehicle 40, from a terminal apparatus used by the at least one participant to the information processing apparatus 10. That is, the second terminal apparatus 30 may be a terminal apparatus used by a participant. In this case, the second terminal apparatus 30 serving as the terminal apparatus used by the participant may acquire the address of the participant as the participant information from the input interface 33, and transmit the participant information to the information processing apparatus 10 via the communication interface 31 and the network 50. The second terminal apparatus 30 is not limited to this, and may transmit the positional information for the second terminal apparatus 30 acquired by the positional information acquisition interface 35 as the participant information to the information processing apparatus 10. The information processing apparatus 10 may determine the pickup information for the vehicle 40 to pick up the participants of the music class, based on the received positional information for the second terminal apparatus 30.

For example, in the embodiment described above, the first terminal apparatus 20 has been described as acquiring the provision location desired by the provider as the provision information from the input interface 23, and transmitting the provision information to the information processing apparatus 10 via the communication interface 21 and the network 50, but is not limited thereto. The first terminal apparatus 20 may transmit the positional information for the first terminal apparatus 20 acquired by the positional information acquisition interface 25 as the provision information to the information processing apparatus 10. The information processing apparatus 10 may determine the procurement information including the location at which the music supply is to be procured, based on the received positional information for the first terminal apparatus 20.

For example, in the embodiment described above, the music class may be held after the information processing apparatus 10 executes the matching and the procurement of the music supply is completed, or the information processing apparatus 10 may execute the matching in real time while the music class is being held, and the music class may be held while the music supply is being procured.

For example, in the embodiment described above, the information processing apparatus 10 has been described as executing the matching by extracting specific holding information and specific provision information, but is not limited thereto. For example, in a case in which there is a plurality of candidate music classes for the matching, the information processing apparatus 10 may transmit candidate information as a list to the first terminal apparatus 20 of the provider. The provider may select the holding information on a specific music class which the provider ultimately desires, while checking a candidate list displayed on the output interface 24 of the first terminal apparatus 20.

For example, in the embodiment described above, the information processing apparatus 10 has been described as executing the matching by extracting specific holding information and specific provision information, but is not limited thereto. For example, in a case in which there is a plurality of candidate providers for the matching, the information processing apparatus 10 may transmit candidate information as a list to the second terminal apparatus 30. The member of staff of the operating company may select the provision information on a specific provider whom the member of staff ultimately desires, while checking a candidate list displayed on the output interface 34 of the second terminal apparatus 30. Similarly, the instructor or the student of the music class may select the provision information on a specific provider whom the instructor or the student ultimately desires, based on the candidate information transmitted from the second terminal apparatus 30 to his/her terminal apparatus.

1. An information processing apparatus comprising a controller configured to:
acquire holding information on a music class to be held in a vehicle and provision information on a provider who provides a music supply to be used in the music class;
execute matching between the music class and the provider based on the holding information and the provision information that are acquired; and
determine procurement information to be notified to the provider according to a result of the matching.

2. The information processing apparatus according to claim 1, wherein, upon receiving the provision information from a first terminal apparatus of the provider, the controller executes the matching by extracting the holding information corresponding to the received provision information, and transmits the determined procurement information to the first terminal apparatus.

3. The information processing apparatus according to claim 1, wherein, upon receiving the holding information from a second terminal apparatus which is separate from a first terminal apparatus of the provider, the controller executes the matching by extracting the provision information corresponding to the received holding information, and transmits the determined procurement information to the first terminal apparatus.

4. The information processing apparatus according to claim 1, wherein the controller is configured to acquire evaluation information indicating a result of an evaluation by one of another from among an instructor and a student of the music class and the provider.

5. The information processing apparatus according to claim 4, wherein
the evaluation information indicates a result of an evaluation of the provider by the instructor or the student, and
the controller is configured to determine a provision fee to be paid to the provider for the music supply, based on the acquired evaluation information for the provider.

6. The information processing apparatus according to claim 1, wherein the controller is configured to determine pickup information for the vehicle to pick up participants including an instructor and a student of the music class, based on participant information on the participants, and to determine a route for navigating the vehicle to a location at which the music supply is to be procured, the location being included in the determined procurement information.

7. A vehicle equipped with the information processing apparatus according to claim 1.

8. An information processing system comprising:
the information processing apparatus according to claim 1;
a first terminal apparatus of the provider, the first terminal apparatus being configured to transmit the provision information to the information processing apparatus; and
a second terminal apparatus which is separate from the first terminal apparatus of the provider, the second terminal apparatus being configured to transmit the holding information to the information processing apparatus.

9. A non-transitory computer readable medium storing a program executable by one or more processors to cause an information processing apparatus to execute functions, the functions comprising:
acquiring holding information on a music class to be held in a vehicle;
acquiring provision information on a provider who provides a music supply to be used in the music class;
executing matching between the music class and the provider based on the holding information and the provision information that are acquired; and
determining procurement information to be notified to the provider according to a result of the matching.

10. The non-transitory computer readable medium according to claim 9, wherein the acquiring of the provision information comprises receiving the provision information from a first terminal apparatus of the provider, and the executing of the matching comprises executing the matching by extracting the holding information corresponding to the received provision information,
the functions further comprising transmitting the procurement information determined by the determining of the procurement information, to the first terminal apparatus.

11. The non-transitory computer readable medium according to claim 9, wherein the acquiring of the holding information comprises receiving the holding information from a second terminal apparatus which is separate from a first terminal apparatus of the provider, and the executing of the matching comprises executing the matching by extracting the provision information corresponding to the received holding information,
the functions further comprising transmitting the procurement information determined by the determining of the procurement information, to the first terminal apparatus.

12. The non-transitory computer readable medium according to claim 9, the functions further comprising acquiring evaluation information indicating a result of an evaluation by one of another from among an instructor and a student of the music class and the provider.

13. The non-transitory computer readable medium according to claim 12, wherein the evaluation information indicates a result of an evaluation of the provider by the instructor or the student,
the functions further comprising determining a provision fee to be paid to the provider for the music supply, based on the evaluation information for the provider acquired by the acquiring of the evaluation information.

14. The non-transitory computer readable medium according to claim 9, the functions further comprising:
determining pickup information for the vehicle to pick up participants including an instructor and a student of the music class, based on participant information on the participants; and
determining a route for navigating the vehicle to a location at which the music supply is to be procured, the location being included in the procurement information determined by the determining of the procurement information.

15. A non-transitory computer readable medium storing a program executable by one or more processors to cause a terminal apparatus of a provider who provides a music supply to be used in a music class, to execute functions, the functions comprising:
transmitting provision information on the provider who provides the music class to be held in a vehicle with the music supply, to an information processing apparatus; and
receiving procurement information determined by the information processing apparatus according to a result of matching between the music class and the provider executed by the information processing apparatus based on holding information on the music class and the provision information that are acquired by the information processing apparatus.

16. The non-transitory computer readable medium according to claim 15, wherein, when the provision information transmitted by the transmitting of the provision information is received by the information processing apparatus, the holding information corresponding to the received provision information is extracted by the information processing apparatus to thereby execute the matching, and the procurement information determined by the information processing apparatus is received by the receiving of the procurement information.

17. The non-transitory computer readable medium according to claim 15, wherein, when the holding information is received by the information processing apparatus from a terminal apparatus which is separate from the terminal apparatus of the provider, the provision information corresponding to the received holding information is extracted by the information processing apparatus to thereby execute the matching, and the procurement information determined by the information processing apparatus is received by the receiving of the procurement information.

18. The non-transitory computer readable medium according to claim 15, the functions further comprising receiving evaluation information acquired by the information processing apparatus, the evaluation information indicating a result of an evaluation of the provider by an instructor or a student of the music class.

19. The non-transitory computer readable medium according to claim 18, the functions further comprising receiving information regarding a provision fee to be paid to the provider for the music supply, which is determined by the information processing apparatus based on the acquired evaluation information for the provider.

20. The non-transitory computer readable medium according to claim 15, wherein the procurement information includes a location at which the music supply is to be procured, the location being located on a route for navigating the vehicle and being determined by the information processing apparatus.
